(19) United States
(12) Patent Application Publication
(10) Pub. No.: US 2008/0162410 A1
(43) Pub. Date: Jul. 3, 2008

(54) METHOD AND APPARATUS FOR AUGMENTING THE DYNAMIC HASH TABLE WITH HOME SUBSCRIBER SERVER FUNCTIONALITY FOR PEER-TO-PEER COMMUNICATIONS

(75) Inventors: Marie Jose Montpetit, Jamaica Plain, MA (US); Sathyam Ganesan, Holden, MA (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/616,818

(22) Filed: Dec. 27, 2006

(51) Int. Cl. G06F 17/30

(52) U.S. Cl. 707/2; 707/E17.052

(57) ABSTRACT

A method and apparatus for augmenting a dynamic hash table (DHT) with home subscriber server (HSS) functionality for an electronic device in a peer-to-peer communications network is disclosed. The method may include, sending a DHT join query to join the peer-to-peer communications network, and determining if the DHT join query is answered. If the DHT query is not answered, the method may include assuming the role of super node, establishing a secure tunnel to an HSS and performing authentication, acquiring a secure key to communicate to the HSS, and answering queries from other nodes in the peer-to-peer communications network. Otherwise, if the DHT join query is answered, the method may include assuming a role other than the super node in the peer-to-peer communications network.

### BACKGROUND OF THE INVENTION

1. Field of the Invention

The invention relates to peer-to-peer network communications.

2. Introduction

A Home Subscriber Server (HSS) is a database of user's characteristics and application information and is usually a part of a telecommunication information structure. It is associated with the IP multimedia subsystem (IMS) which is used for all IP communications.

In joining a peer-to-peer (p2p) network, the manner that a node announces itself and the way it finds other peers in the network is to send a dynamic hash table (DHT). DHT is a method for storing hash tables in geographically distributed locations in order to provide a failsafe lookup mechanism for distributed computing. Various algorithms have been explored that provide the right balance and speed for storing parts of the tables in different locations. While DHTs were used in the early and mid-1990s for local area network storage, in the 2000s, DHTs are being utilized for peer-to-peer computing over the Internet.

A DHT provides a fault tolerant storage interface on top of which is layered an application, such as music sharing, file sharing or distributed backup. The DHT includes an identifier for the nodes, the location of the nodes (e.g., IP address), and sometimes a description about the type of device. Usually, a DHT is extremely small because the node does not know who the other peers in your network and it would be undesirable to overflow the network with useless information.

The HSS and DHT are two completely different entities. The HSS contains a lot of information, but is very large and it lacks control of the nodes. The DHT network provides limited information between nodes but allows communication from node to node. It would be preferable to find a way to provide the advantages of each HSSs and DHTs.

### SUMMARY OF THE INVENTION

A method and apparatus for augmenting a dynamic hash table (DHT) with home subscriber server (HSS) functionality for an electronic device in a peer-to-peer communications network is disclosed. The method may include, sending a DHT join query to join the peer-to-peer communications network, and determining if the DHT join query is answered. If the DHT query is not answered, the method may include assuming the role of super node, establishing a secure tunnel to an HSS and performing authentication, acquiring a secure key to communicate to the HSS, and answering queries from other nodes in the peer-to-peer communications network. Otherwise, if the DHT join query is answered, the method may include assuming a role other than the super node in the peer-to-peer communications network.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a peer-to-peer network in accordance with a possible embodiment of the invention;

FIG. 2 illustrates a block diagram of an exemplary super node in accordance with a possible embodiment of the invention;

FIG. 3 is an exemplary flowchart illustrating one possible super node establishment process in accordance with one possible embodiment of the invention; and

FIG. 4 is an exemplary flowchart illustrating one possible query processing process in accordance with one possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The invention comprises a variety of embodiments, such as a method and apparatus and other embodiments that relate to the basic concepts of the invention.

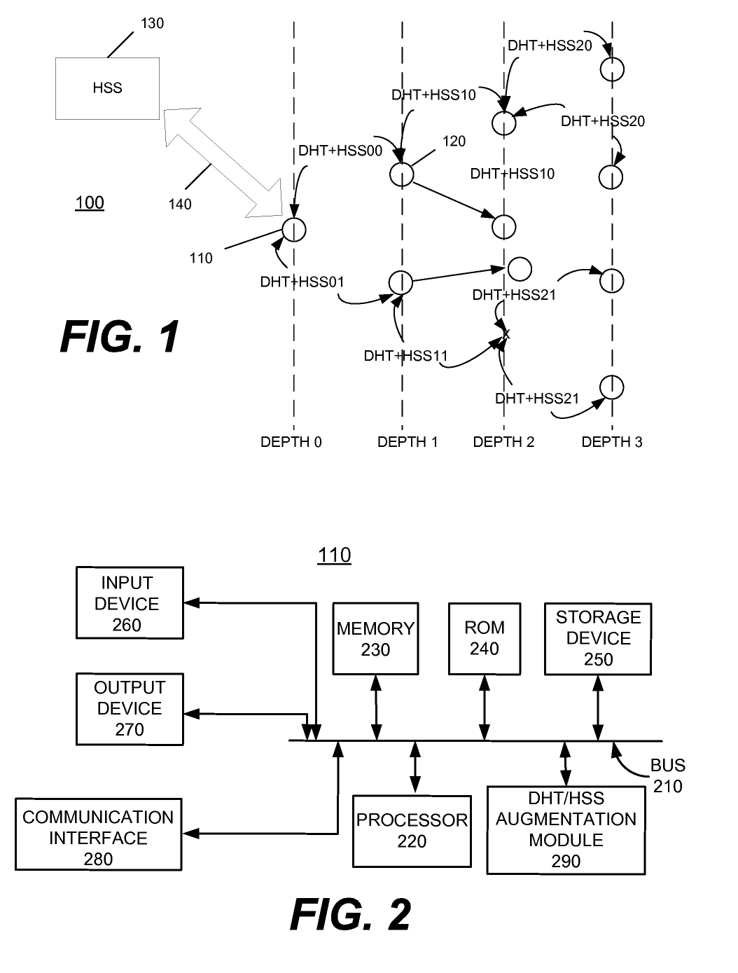

FIG. 1 illustrates an exemplary diagram of peer-to-peer network 100 in accordance with a possible embodiment of the invention. In particular, the peer-to-peer network 100 may include a super node 110, a plurality of generic nodes 120, an HSS 130, and a secure tunnel 140 which connects the super node 110 to the HSS 130. While only one super node 110 is shown, secondary or tertiary super nodes may exist. In addition, a super node 110 may service multiple peer-to-peer networks 100. Furthermore, a super node 110 may be connected to more than one HSS 130 through another secure tunnel 140, within the spirit and scope of the invention.

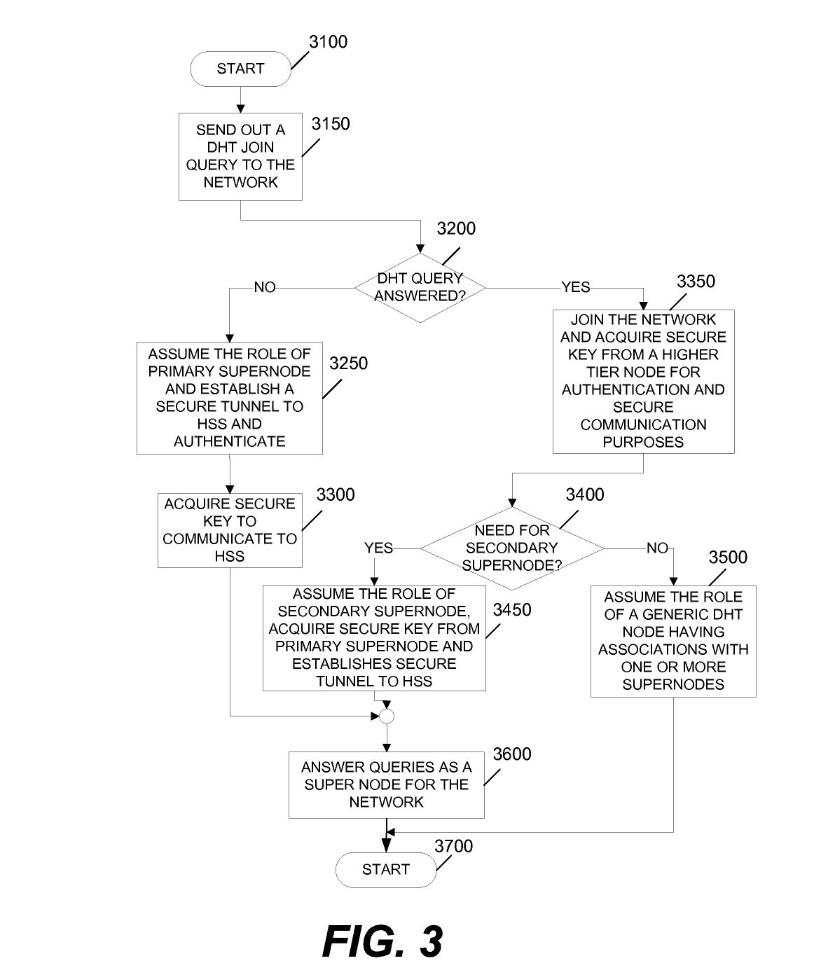

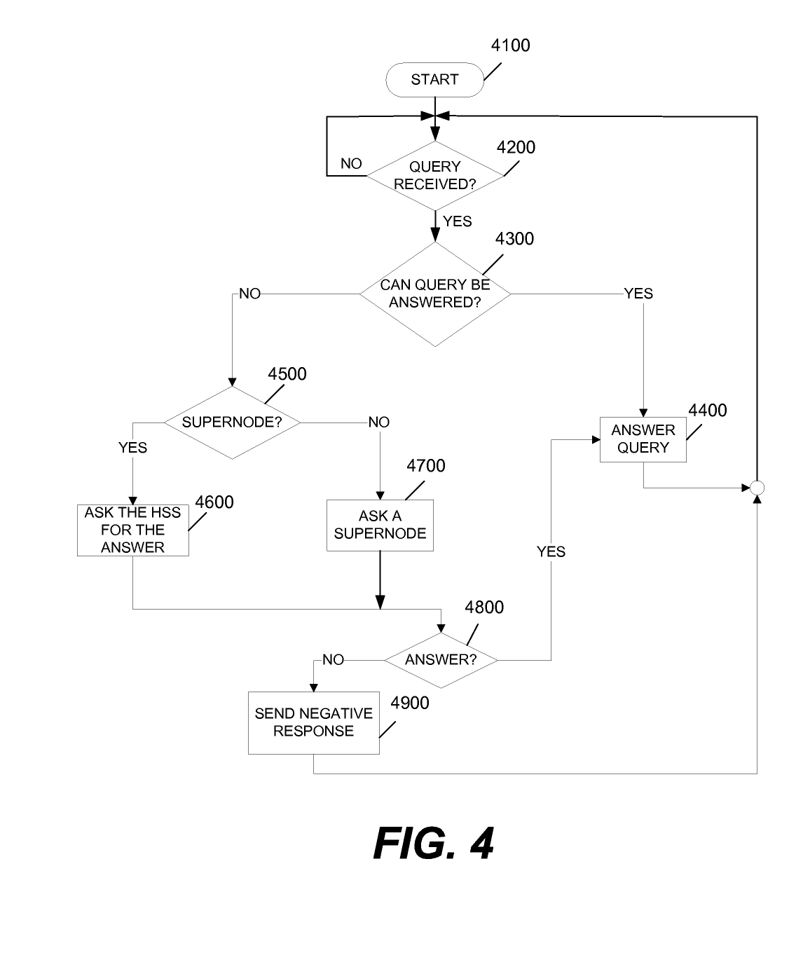

FIG. 2 illustrates an exemplary super node 110, or device which may implement one or more modules or functions of the peer-to-peer network processes shown below in FIGS. 3 and 4. Thus, exemplary super node 110 may include a bus 210, a processor 220, a memory 230, a read only memory (ROM) 240, a storage device 250, an input device 260, an output device 270, a communication interface 280, and DHT/HSS augmentation module 290. Bus 210 may permit communication among the components of the super node 110.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media, such as, for example, magnetic or optical recording media and its corresponding drive.

Input device 260 may include one or more conventional mechanisms that permit a user to input information to the super node 110, such as a keyboard, a mouse, a pen, a voice recognition device, etc. Output device 270 may include one or more conventional mechanisms that output information to the user, including a display, a printer, one or more speakers, or a medium, such as a memory, or a magnetic or optical disk and a corresponding disk drive. Communication interface 280 may include any transceiver-like mechanism that enables the super node 110 to communicate via a network. For example, communication interface 280 may include a modem, or an Ethernet interface for communicating via a local area network (LAN). Alternatively, communication interface 280 may include other mechanisms for communicating with other devices and/or systems via wired, wireless or optical connections. In some implementations of the super node 110, communication interface 280 may not be included in the exemplary super node 110 when the peer-to-peer network process is implemented completely within the super node 110.

The super node 110 may perform such functions in response to processor 220 by executing sequences of instructions contained in a computer-readable medium, such as, for example, memory 230, a magnetic disk, or an optical disk. Such instructions may be read into memory 230 from another computer-readable medium, such as storage device 250, or from a separate device via communication interface 280.

The peer-to-peer network 100 and the super node 110 illustrated in FIG. 1 and the related discussion are intended to provide a brief, general description of a suitable computing environment in which the invention may be implemented. Although not required, the invention will be described, at least in part, in the general context of computer-executable instructions, such as program modules, being executed by the super node 110, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

For illustrative purposes, the DHT/HSS augmentation module 290 and peer-to-peer network processes will be described below in FIGS. 3 and 4 in relation to the block diagrams shown in FIGS. 1 and 2.

FIG. 3 is an exemplary flowchart illustrating one possible super node establishment process in accordance with one possible embodiment of the invention. The process begins at step 3100 and continues to step 3150 where the DHT/HSS augmentation module 290 sends out a DHT join query to the peer-to-peer network 100. At step 3200, the DHT/HSS augmentation module 290 determines whether the DHT query was answered. If the DHT query was not answered, at step 3250, the DHT/HSS augmentation module 290 will perform the actions necessary so that the node on which it resides will assume the role of primary super node 110. In particular, the DHT/HSS augmentation module 290 will establish a secure tunnel to the HSS 130 and authenticate.

At step 3300, the DHT/HSS augmentation module 290 acquires a secure key to communicate to the HSS 130. At step 3600, the DHT/HSS augmentation module 290 answers queries as the super node 110 for the peer-to-peer network 100. The process then goes to step 3700, and ends.

If the DHT query was answered at step 3200, at step 3350, the DHT/HSS augmentation module 290 will perform the actions necessary so that the node on which it resides will assume a role other than the super node 110. In particular, the DHT/HSS augmentation module 290 allows the node to join the peer-to-peer network 100 and acquire the secure key from the higher-tier node for authentication and secure communication purposes.

At step 3400, the DHT/HSS augmentation module 290 determines if there is a need for a secondary super node. If the DHT/HSS augmentation module 290 determines that there is no need for a secondary super node, at step 3500, the DHT/HSS augmentation module 290 will perform the actions necessary so that the node on which it resides will assume the role of a generic DHT node 120 that may have associations with one or more super nodes 110. The process then goes to step 3700, and ends.

If at step 3400, the DHT/HSS augmentation module 290 determines that there is a need for a secondary super node, at step 3450, the DHT/HSS augmentation module 290 will perform actions necessary to have the node on which it resides in assume the role of secondary super node. The DHT/HSS augmentation module 290 will acquire a secure key from the primary super node 110 and establish a secure tunnel to the HSS 130. At step 3600, the DHT/HSS augmentation module 290 will answer queries as a secondary super node for the peer-to-peer network. The process then goes a step 3700, and ends.

FIG. 4 is an exemplary flowchart illustrating one possible query processing process for the peer-to-peer network 100 in accordance with one possible embodiment of the invention. The process begins at step 4100 and continues to step 4200, where the DHT/HSS augmentation module 290 determines whether a query has been received from another node. If the DHT/HSS augmentation module 290 determines that a query has not been received, the DHT/HSS augmentation module 290 will return to step 4200 and wait until a query is received.

If the DHT/HSS augmentation module 290 determines that a query has been received at step 4200, then at step 4300 the DHT/HSS augmentation module 290 determines whether the query can be answered. If the DHT/HSS augmentation module 290 determines that the query can be answered, at step 4400, the DHT/HSS augmentation module 290 answers the query. The process then returns to step 4200 where the DHT HSS augmentation module 290 waits for the next query.

If at step 4300, the DHT/HSS augmentation module 290 determines that the query cannot be answered, at step 4500, the DHT/HSS augmentation module 290 determines if it is the super node 110. If the DHT/HSS augmentation module 290 determines that it is a super node 110, at step 4600, the DHT/HSS augmentation module 290 asks the HSS 130 for the answer to the query. Alternatively, if the DHT HSS augmentation module 290 determines that it is not the super node 110, at step 4700, DHT/HSS augmentation module 290 asks a super node 110 for the answer to the query.

In either case, at step 4800, the DHT/HSS augmentation module 290 determines whether an answer has been received. If the DHT/HSS augmentation module 290 determines that an answer has been received from either the HSS 130 or a super node 110, the process goes to step 4400 and the DHT/HSS augmentation module 290 answers the query. The process then returns to step 4200 where the DHT/HSS augmentation module 290 waits for another query.

If the DHT/HSS augmentation module 290 determines at step 4800 that an answer has not been received, at step 4900, the DHT/HSS augmentation module 290 sends a negative response to the querying node and the process returns to step 4200 where the DHT/HSS augmentation module 290 waits for another query.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the super node 110 in FIGS. 1 and 2 each processing the content in various possible ways. It does not necessarily need to be one system used by all end users. Accordingly, the appended claims and their legal equivalents should only define the invention, rather than any specific examples given.

We claim:

1. A method for augmenting a dynamic hash table (DHT) with home subscriber server (HSS) functionality for an electronic device in a peer-to-peer communications network, comprising:
sending a DHT join query to join the peer-to-peer communications network;
determining if the DHT join query is answered, wherein if the DHT query is not answered:
assuming the role of super node;
establishing a secure tunnel to an HSS and performing authentication;
acquiring a secure key to communicate to the HSS; and
answering queries from other nodes in the peer-to-peer communications network;
otherwise, if the DHT join query is answered, assuming a role other than the super node in the peer-to-peer communications network.

2. The method of claim 1, wherein if the DHT join query is answered, further comprising:
joining the peer-to-peer communications network;
acquiring a secure key from a higher-tier node for authentication and secure communication purposes.

3. The method of claim 2, further comprising:
determining if there is a need for a secondary super node, wherein if there is a need for a secondary super node:
assuming the role of secondary super node;
acquiring a secure key from the super node;
establishing a secure tunnel to the HSS; and
answering queries as the secondary super node for the peer-to-peer communications network;
otherwise, assuming a role other than a secondary super node in the peer-to-peer communications network.

4. The method of claim 1, further comprising:
determining that a query has been received from a querying node;
determining that the received query can not be answered;
querying one of the HSS and another super node for an answer to the query; and
outputting one of an answer and a negative response to the querying node.

5. The method of claim 4, wherein if it is determined that a query has not been received, waiting for a query to be received.

6. The method of claim 4, wherein if it is determined that the query can be answered, further comprising:
answering the query; and
waiting for the next query.

7. The method of claim 4, wherein the HSS is queried for an answer if the electronic device is a super node, and another super node is queried if the electronic device is not a super node.

8. An apparatus for augmenting a dynamic hash table (DHT) with home subscriber server (HSS) functionality for an electronic device in a peer-to-peer communications network, comprising:
a communication interface;
a DHT/HSS augmentation module that sends a DHT join query to join the peer-to-peer communications network, determines if the DHT join query is answered, wherein if the DHT query is not answered:
the DHT/HSS augmentation module enables the electronic device to assume the role of super node, establishes a secure tunnel using the communication interface with an HSS and performs authentication, acquires a secure key to communicate to the HSS, and answers queries from other nodes in the peer-to-peer communications network,
otherwise, the DHT/HSS augmentation module determines that the DHT join query is answered, the DHT/HSS augmentation module enables the electronic device to assume a role other than the super node in the peer-to-peer communications network.

9. The apparatus of claim 8, wherein if the DHT/HSS augmentation module determines that the DHT join query is answered, the DHT/HSS augmentation module enables the electronic device to join the peer-to-peer communications network, and acquires a secure key from a higher-tier node for authentication and secure communication purposes.

10. The apparatus of claim 9, wherein the DHT/HSS augmentation module determines if there is a need for a secondary super node, wherein if there is a need for a secondary super node:
the DHT/HSS augmentation module enables the electronic device to assume the role of secondary super node, acquires a secure key from the super node, establishes a secure tunnel to the HSS, and answers queries as the secondary super node for the peer-to-peer communications network,
otherwise, the DHT/HSS augmentation module enables the electronic device to assume a role other than a secondary super node in the peer-to-peer communications network.

11. The apparatus of claim 8, wherein the DHT/HSS augmentation module determines that a query has been received from a querying node, determines that the received query can not be answered, queries one of the HSS and another super node for an answer to the query, and outputs one of an answer and a negative response to the querying node.

12. The apparatus of claim 11, wherein if the DHT/HSS augmentation module determines that a query has not been received, the DHT/HSS augmentation module waits for a query to be received.

13. The apparatus of claim 11, wherein if the DHT/HSS augmentation module determines that the query can be answered, the DHT/HSS augmentation module answers the query, and waits for the next query.

14. The apparatus of claim 11, wherein the DHT/HSS augmentation module queries the HSS for an answer if the electronic device is a super node and queries another super node if the electronic device is not a super node.

15. An electronic device that augments a dynamic hash table (DHT) with home subscriber server (HSS) functionality in a peer-to-peer communications network, comprising:
a communication interface;
a transceiver for sending and receiving signals using the communication interface; and
a DHT/HSS augmentation module that sends a DHT join query to join the peer-to-peer communications network, determines if the DHT join query is answered, wherein if the DHT query is not answered:
the DHT/HSS augmentation module enables the electronic device to assume the role of super node, establishes a secure tunnel using the communication interface with an HSS and performs authentication, acquires a secure key to communicate to the HSS, and answers queries from other nodes in the peer-to-peer communications network,
otherwise, the DHT/HSS augmentation module determines that the DHT join query is answered, the DHT/HSS augmentation module enables the electronic device to assume a role other than the super node in the peer-to-peer communications network.

16. The electronic device of claim 15, wherein if the DHT/HSS augmentation module determines that the DHT join query is answered, the DHT/HSS augmentation module enables the electronic device to join the peer-to-peer communications network, and acquires a secure key from a higher-tier node for authentication and secure communication purposes.

17. The electronic device of claim 16, wherein the DHT/HSS augmentation module determines if there is a need for a secondary super node, wherein if there is a need for a secondary super node:
the DHT/HSS augmentation module enables the electronic device to assume the role of secondary super node, acquires a secure key from the super node, establishes a secure tunnel to the HSS, and answers queries as the secondary super node for the peer-to-peer communications network,
otherwise, the DHT/HSS augmentation module enables the electronic device to assume a role other than a secondary super node in the peer-to-peer communications network.

18. The electronic device of claim 15, wherein the DHT/HSS augmentation module determines that a query has been received from a querying node, determines that the received query can not be answered, queries one of the HSS and another super node for an answer to the query, and outputs one of an answer and a negative response to the querying node.

19. The electronic device of claim 18, wherein if the DHT/HSS augmentation module determines that the query can be answered, the DHT/HSS augmentation module answers the query, and waits for the next query.

20. The electronic device of claim 19, wherein the DHT/HSS augmentation module queries the HSS for an answer if the electronic device is a super node and queries another super node if the electronic device is not a super node.
